(19) United States
(12) Patent Application Publication
(10) Pub. No.: US 2020/0363852 A1
(43) Pub. Date: Nov. 19, 2020

(54) ELECTRONIC APPARATUS AND CONTROL METHOD THEREOF

(71) Applicant: SAMSUNG ELECTRONICS CO., LTD., Suwon-si (KR)

(72) Inventor: Youngho Choi, Suwon-si (KR)

(73) Assignee: SAMSUNG ELECTRONICS CO., LTD., Suwon-si (KR)

(21) Appl. No.: 16/872,951

(22) Filed: May 12, 2020

(30) Foreign Application Priority Data
May 16, 2019 (KR) 10-2019-0057426

(51) Int. Cl. G06F 1/26; G08C 23/04; G06F 1/3287

(52) U.S. Cl. CPC G06F 1/266; G16Y 40/35; G06F 1/3287; G08C 23/04

(57) ABSTRACT

An electronic apparatus includes a communication interface connected to a display device, a power interface connected to an external source device, and a processor configured to control the power interface to supply power to the external source device, control the communication interface to transmit content provided from the first external source device, to the display device, and based on at least one of a control signal received from the display device and whether a source device providing the content is changed, stop supplying the power to the external source device.

### CROSS-REFERENCE TO RELATED APPLICATION(S)

This application is based on and claims priority under 35 U.S.C. § 119 to Korean Patent Application No. 10-2019-0057426, filed on May 16, 2019, in the Korean Intellectual Property Office, the disclosure of which is incorporated by reference herein in its entirety.

### BACKGROUND

### 1. Field

The disclosure relates to an electronic apparatus and a control method thereof, and more particularly, to an electronic apparatus for providing power to an external electronic apparatus and a method of controlling the same.

### 2. Description of Related Art

Recently, there has been an increasing demand for a smart plug for utilizing Internet of Things (IoT) devices. A user may control the smart plug with a smartphone to turn off or turn on a device connected to a socket or outlet, and automatically turn off the device at night when the device is not in use by using a timer, thereby reducing unnecessary power consumption.

However, since the smart plug includes an internal control circuit for Wi-Fi communication, and the internal control circuit is always in a standby state, and thus, there is a problem that additional power is consumed to operate the internal control circuit.

Generally, in order to use a device connected to a smart plug, the smart plug must be turned on so as to allow the connected device to receive power through the smart plug. However, when power is blocked by a smart plug in a turned off state, it is necessary to control the smart plug by using another device, such as a smartphone, to turn on the smart plug, thereby causing inconvenience to a user.

Accordingly, there is a need to develop a method for solving inconvenience of a user while minimizing the power consumption to operate the standby power mode of an unused device.

### SUMMARY

In accordance with an aspect of the disclosure, there is provided an electronic apparatus including a communication interface configured to be connected to a display device, a power interface configured to be connected to a first external source device, and a processor. The processor may be configured to: control the power interface to supply power to the first external source device, control the communication interface to transmit content provided from the first external source device, to the display device, and based on at least one of a control signal received from the display device and whether a source device providing the content is changed, stopping supplying the power to the first external source device.

The processor may be further configured to, based on a control signal to turn off the display device being received from the display device, control the power interface to stop supplying the power to the first external source device.

The processor may be further configured to: based on the control signal to turn off the display device being received from the display device, control the power interface to transmit a request for operation state information of the first external source device, to the first external source device; based on the operation state information being received from the first external source device, determining whether to supply the power to the first external source device; and based on a control signal to turn on the first external source device being received from the display device, provide the power and the operation state information to the first external source device.

The electronic apparatus may further include: a first data interface configured to be connected to the external source device. The processor may be further configured to: provide the content received through the first data interface to the display device, and based on a control signal to change the first external source device providing the content to a second external source device being received from the display device, stop supplying the power to the first external source device.

The electronic apparatus may further include: a second data interface configured to be connected to the second external source device; and a second power interface configured to be connected to the second external source device. The processor may be further configured to: based on the control signal to change the first external source device providing the content to the second external source device being received from the display device, supply power to the second external source device through the second power interface, and provide the content received through the second data interface to the display device.

The electronic apparatus may further include: a first data interface configured to be connected to the first external source device; and a second data interface connected to a second external source device. The processor may be further configured to: based on second content from the second external source device being received through the second data interface while the content received through the first data interface being provided to the display device, stop supplying the power to the first external source device and provide the second content to the display device.

The electronic apparatus may further include: an infrared (IR) transmitter. The processor may be further configured to: based on a control signal to turn off the display device being received from the display device, control the IR transmitter to transmit a turn-off command to the first external source device, and based on a control signal to turn on the display device being received from the display device, control the IR transmitter to transmit a turn-on command to the first external source device.

The electronic apparatus may further include a storage. The processor may be further configured to: store usage pattern information including an operation state of the display device and an operation state of the first external source device in the storage by time intervals, and stop supplying the power to the first external source device based on the usage pattern information.

The electronic apparatus may further include: a power supply configured to provide the power; and a relay disposed between the power supply and the power interface. The processor may be further configured to stop supplying the power to the external source device by opening the relay between the power supply and the power interface.

The power supply is further configured to output the power to the power interface based on an external power and output a first direct current (DC) power at a first voltage level and a second DC power at a second voltage level, the second voltage level being lower than the first voltage level. The processor is further configured to, based on a control signal to turn off the display device being received from the display device, stop supplying power to the first external source device and supplying the first DC power to the display device.

The processor is further configured to: provide setting information on a user interface (UI) screen on the display device for setting a power supply time for the first external source device, and based on the setting information of the power supply time being received from the display device, stop supplying the power to the first external source device based on the received setting information.

In accordance with an aspect of the disclosure, there is provided a control method of an electronic apparatus. The method may include: supplying power to a first external source device through a power interface; transmitting content provided from the first external source device, to a display device through a communication interface; and based on at least one of a control signal received from the display device and whether a source device providing the content is changed, stopping supplying the power to the first external source device.

The stopping the supplying the power may further include, based on a control signal to turn off the display device being received from the display device, stopping the supplying power to the first external source device.

The stopping the supplying the power may further include: based on the control signal to turn off the display device being received from the display device, transmitting a request for operation state information of the first external source device, to the first external source device; based on receiving the operation state information from the first external source device, determining whether to supply the power to the first external source device. The control method may further include, based on a control signal to turn on the first external source device being received from the display device, providing the power and the operation state information to the first external source device.

The providing content may further include providing, to the display device, content received through a first data interface connected to the first external source device, and the stopping may further include, based on a control signal to change the first external source device providing the content to a second external source device being received from the display device, stopping the supplying the power to the first external source device.

The method may further include: based on the control signal to change the first external source device providing the content to the second external source device being received from the display device, supplying power to the second external source device through a second power interface connected to the second external source device; and providing, to the display device, second content received through the second data interface connected to the second external source device.

The stopping the supplying the power may further include: based on receiving second content from a second external source device through a second data interface connected to the second external device while the content received through the first data interface is being provided to the display device, stopping the supplying the power to the first external source device, and the control method may further include providing the second content to the display device.

The method may further include: based on a control signal to turn off the display device being received from the display device, transmitting a turn-off command to the first external source device, and based on a control signal to turn on the display device being received from the display device, transmitting a turn-on command to the first external source device.

The method may further include: storing usage pattern information including an operation state of the display device and an operation state of the first external source device by time intervals, and the stopping may further include stopping the supplying the power to the first external source device based on the usage pattern information.

The method may further include: providing setting information on a user interface (UI) screen on the display device for setting a power supply time for the first external source device, and the stopping may further include, based on receiving the setting information of the power supply time from the display device, stopping the supplying the power to the first external source device based on the received setting information.

### BRIEF DESCRIPTION OF THE DRAWINGS

The above and other aspects, features, and advantages of certain embodiments of the disclosure will be more apparent from the following detailed description, taken in conjunction with the accompanying drawings, in which:

FIG. 1A is a diagram illustrating a configuration of an electronic system according to an embodiment;

FIG. 1B is a diagram illustrating a configuration of an electronic system according to another embodiment;

FIG. 2A is a block diagram illustrating an example of a configuration of an electronic apparatus according to an embodiment;

FIG. 2B is a block diagram illustrating an example of a detailed configuration of an electronic apparatus according to an embodiment;

FIG. 3 is a diagram illustrating an operation of an electronic apparatus and a plurality of external source devices according to an embodiment;

FIG. 4 is a diagram illustrating an internal circuit of an electronic apparatus according to an embodiment;

FIG. 5A is a diagram illustrating a user interface (UI) screen according to an embodiment;

FIG. 5B is a diagram illustrating a user interface (UI) screen according to another embodiment;

FIG. 6A is a diagram illustrating a method for using a usage pattern according to an embodiment;

FIG. 6B is a diagram illustrating a method for using a usage pattern according to another embodiment;

FIG. 7 is a sequence diagram illustrating a method for controlling an operation of an external source device according to an embodiment;

FIG. 8 is a sequence diagram illustrating a method for controlling an operation of an external source device according to an embodiment; and

FIG. 9 is a flowchart illustrating a control method of an electronic apparatus according to an embodiment.

### DETAILED DESCRIPTION

The embodiments of the disclosure may be modified in various ways. Specific embodiments are illustrated in the accompanying drawings and are described in detail herein. However, it is to be understood that the present disclosure is not limited to a specific embodiment, but may include all modifications, equivalents, and substitutions without departing from the scope and spirit of the present disclosure. Also, well-known functions or constructions related to the disclosure that may obscure the gist of the disclosure may be omitted.

Hereinafter, various embodiments of the disclosure will be described with reference to the accompanying drawings. Throughout the accompanying drawings, similar components will be denoted by similar reference numerals.

The disclosure relates to an electronic apparatus for blocking standby power of an external source device and a control method thereof.

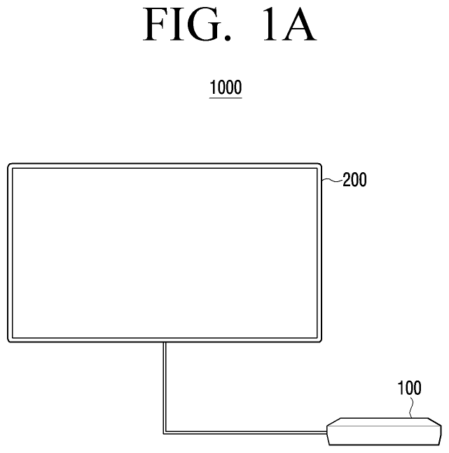

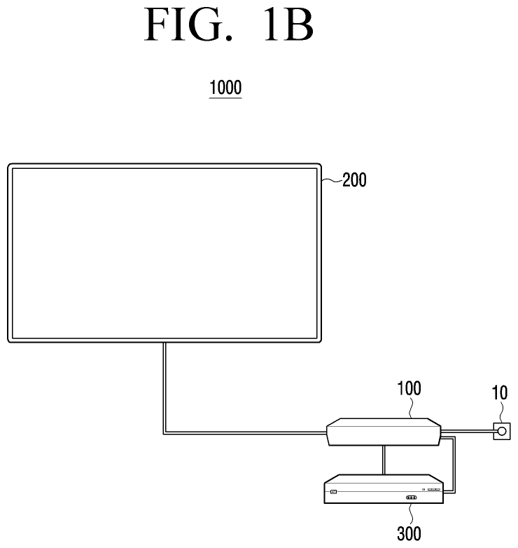

FIG. 1A is a block diagram illustrating a configuration of an electronic system 1000 according to an embodiment. Referring to FIG. 1A, the electronic system 1000 may include an electronic apparatus 100 and a display device 200.

The electronic apparatus 100 may supply power to the display device 200. For example, the electronic apparatus 100 may convert alternating current (AC) power to direct current (DC) power and supply the power to the display device 200. Alternatively, the electronic apparatus 100 may convert the power source to a plurality of DC power sources having a plurality of voltage levels and supply a plurality of DC power to the display device 200. Alternatively, the electronic apparatus 100 may supply AC power to the display device 200.

The electronic apparatus 100 may be a device such as a one connect box and may provide content to the display device 200. For example, the electronic apparatus 100 may decode content and transmit a video signal and an audio signal of the decoded content to the display device 200. For example, the electronic apparatus 100 may convert the video signal and the audio signal of the decoded content into an optical signal and transmit the optical signal to the display device 200. However, the embodiment is not limited thereto. The electronic apparatus 100 may transmit the video signal and the audio signal of the decoded content to the display device 200 without converting the video signal and the audio signal, or may convert the video signal and the audio signal of the decoded content into another type of signal and transmit the converted video signal and the audio signal to the display device 200. The content may include any content stored in the electronic apparatus 100 or content received from the outside.

The display device 200 may be a device that receives power from the electronic apparatus 100 and may be driven based on the received power.

The display device 200 may include a display that receives content from the electronic apparatus 100, and displays the received content. The display device 200 may or may not perform image processing on the content. For example, the display device 200 may be a device including only a display panel. In such case, the electronic apparatus 100 may transmit the decoded content to the display device 200, and the display device 200 may display the received content. Alternatively, the electronic apparatus 100 may transmit some data of the decoded content to the display device 200, the display device 200 may store the received data in a buffer and display the content from the data stored in the buffer. The electronic apparatus 100 may have an image processing function of a conventional display device capable of processing an image, transmitting the image-processed content to the display device 200, and the display device 200 may receive and display the image-processed content. Additionally, the electronic apparatus 100 may include a power block for supplying power in addition to an image processing block for performing an image processing function, and the power block may supply power to an external source device 300 to be described later.

The electronic apparatus 100 may receive an encoded content from the outside, decode the received content, and transmit the decoded content to the display device 200.

The display device 200 may reproduce a video signal and an audio signal received from the electronic apparatus 100.

As described above, the display device 200 may be supplied with power from the electronic apparatus 100, and receive the decoded content from the electronic apparatus 100 to display the content. That is, since the image processing block and the power block are removed from the display device 200, the display device 200 may be relatively smaller and thinner compared to the conventional display device.

The display included in the display device 200 may be implemented in various forms such as a liquid crystal display (LCD), an organic light emitting diode (OLED) display, a plasma display panel (PDP), or the like. A backlight unit, or the like, may also be included in the display. The display may also be implemented as a touch screen in combination with a touch detection unit.

The display device 200 may transmit a control command to the electronic apparatus 100. For example, the display device 200 may include an infrared (IR) receiver and transmit the control command received from a remote control device to the electronic apparatus 100. The control command received from the remote control device may include a control command to turn on or off the display device 200, a control command to change a source device, a control command to control the electronic apparatus 100, or the like.

In FIG. 1A, it has been described that the electronic apparatus 100 supplies power to the display device 200 through one cable (e.g., a magic cable) and transceiver data to the display device 200, but the embodiment is not limited thereto. For example, one cable may be divided into a power cable and a data cable, and the electronic apparatus 100 may be connected to the display device 200 through two cables.

FIG. 1B is a block diagram illustrating a configuration of an electronic system according to another embodiment. As illustrated in FIG. 1B, the electronic system 1000 may further include an external source device 300 in addition to the electronic apparatus 100 and the display device 200.

The electronic apparatus 100 may receive power from a power socket 10, and supply power to the display device 200 and the external source device 300. For example, the electronic apparatus 100 may include an interface of the same standard as the power socket 10 and the external source device 300 may receive power through the interface of the electronic apparatus 100 or the power socket 10.

The electronic apparatus 100 may stop supplying power to the external source device 300. For example, when the electronic apparatus 100 receives a control signal for turning off the display device 200 from the display device 200, the electronic apparatus 100 may stop supplying power to the external source device 300. The electronic apparatus 100 may supply only a minimum power to operate the display device 200 in a standby mode. Here, the standby mode may refer to a state in which only a minimum function is performed, such as an operation of the display device 200 receiving the control signal transmitted from the remote control device.

The external source device 300 may be a device providing content to a display device. For example, the external source device 300 may be a set-top box (STB), a digital video disc (DVD) player, or the like, but these are merely examples, and any device capable of providing content may be the external source device 300.

The external source device 300 may receive power from the electronic apparatus 100. The external source device 300 may receive power from the electronic apparatus 100 via a first cable.

The first cable may be a cable for receiving power from the power socket 10, and since the electronic apparatus 100 includes the interface in the same standard as the power socket 10, the external source device 300 may receive power through the first cable connected to the interface of the electronic apparatus 100. For example, the external source device 300 may receive power of 110 volt (V) or 220V from the electronic apparatus 100 via the first cable. However, the first cable is not limited thereto, and the first cable may have any standard if the first cable may receive power.

The external source device 300 may provide content to the display device 200 through the electronic apparatus 100. The external source device 300 may provide content to the electronic apparatus 100 via a second cable. The external source device 300 may encode content, and provide the encoded content to the electronic apparatus 100.

The second cable may be a cable of a standard capable of transmitting and receiving content or control signals through a standard such as digital visual interface (DVI), display port (DP), high definition multimedia interface (HDMI), component, RS232C communication. However, the second cable may be any standard capable of transmitting and receiving content or control signals.

The external source device 300 may receive a control command from the electronic apparatus 100. In particular, the external source device 300 may receive a control command from the electronic apparatus 100 via the second cable. Here, the control command may be input through the display device 200.

In FIG. 1B, the external source device 300 is connected to the electronic apparatus 100 through the first cable and the second cable, but the embodiment is not limited thereto. For example, the external source device 300 may receive power from the electronic apparatus 100 via the first cable and transceive data with the external source device 300 via wireless communication.

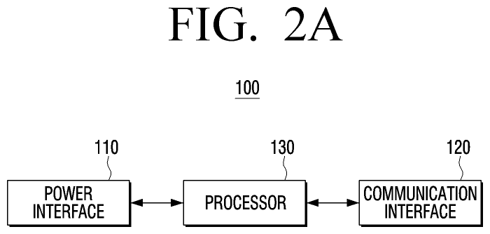

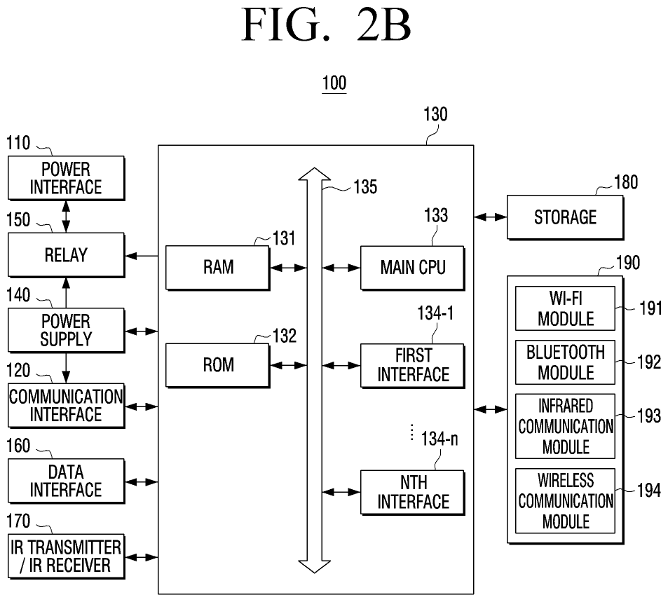

FIG. 2A is a block diagram illustrating an example of a configuration of the electronic apparatus 100 according to an embodiment.

Referring to FIG. 2A, the electronic apparatus 100 may include a power interface 110, a communication interface 120, and a processor 130.

The power interface 110 may be an interface and include circuitry for supplying power to other electronic devices. For example, the power interface 110 may be connected to a plug of the first cable connected to the external source device 300, such as a smart socket. Through the plug and the first cable, the electronic apparatus 100 may supply power to the external source device 300 via the power interface 110.

The electronic apparatus 100 may receive power from the power socket 10 and supply power to the external source device 300 via the power interface 110 and the first cable. The electronic apparatus 100 may further include a separate cable for receiving power from the power socket 10.

The communication interface 120 may be an interface connected to the display device 200 and include circuitry for supplying power to the display device 200, to transceive data with the display device 200.

For example, the electronic apparatus 100 may convert the 90V-264V power input from the power socket 10 to 350 V DC power, and supply the converted DC power to the display device 200 through the communication interface 120. The electronic apparatus 100 may also receive a control command from the display device 200 via the communication interface 120. Alternatively, the electronic apparatus 100 may provide content to the display device 200 via the communication interface 120. In particular, the electronic apparatus 100 may transmit a video signal and an audio signal of the decoded content to the display device 200 via the communication interface 120.

The processor 130 may control overall operations of the electronic apparatus 100.

The processor 130 may include various processing circuitry including, for example, a digital signal processor (DSP) for processing a digital image signal, a microprocessor, a time controller (TCON), or the like, but is not limited thereto. The processor 130 may further include various processing circuitry, such as one or more of a central processing unit (CPU), a micro controller unit (MCU), a micro processing unit (MPU), a controller, an application processor (AP), a graphics-processing unit (GPU), a communication processor (CP), an Advanced Reduced instruction set computing Machine (Advanced RISC ARM) processor, or the like. The processor 130 may be implemented in a system on chip (SoC) type or a large scale integration (LSI) type in which a processing algorithm is built therein or in a field programmable gate array (FPGA) type. The processor 130 may perform various functions by executing computer executable instructions stored in the memory.

The processor 130 may supply power to the external source device 300 via the power interface 110, provide content to the display device 200 via the communication interface 120, or stop supplying power to the external source device 300 based on a control signal or content received from the display device 200 being changed.

The processor 130 may adjust power being supplied to the external source device 300 based on a control signal received from the display device 200. For example, based on receiving a control signal for turning off the display device 200 from the display device 200, the processor 130 may control the power interface 110 to stop supplying power to the external source device 300.

In addition, when a control signal for turning off the display device 200 is received from the display device 200, the processor 130 may transmit a request, to the external source device, for the operation state information of the external source device 300. When the operation state information is received from the external source device 300, the processor 130 may stop supplying power to the external source device 300, and when a control signal for turning on the external source device 300 is received from the display device 200, the processor 130 may provide power and operation state information to the external source device 300.

For example, if a control signal for turning off the display device 200 is received from the display device 200, the processor 130 may request and receive the operation state information of the set-top box, and stop the supply of power to the set-top box. The operation state information may include a channel number, sound output information, or the like of the content provided by the set-top box to the electronic apparatus 100 just before the power supply of the set-top box is stopped. Thereafter, when a control signal for turning on the set-top box is received from the display device 200, the processor 130 may provide power and operation state information to the set-top box.

If the power supply is stopped, current state information, user setting information, and so on, of the external source device 300 may all be deleted. In such case, the external source device 300 may perform an initialization operation at the time of re-driving, and a critical time may be required for initial driving. Therefore, when the processor 130 provides, to the external source device 300, the operation state information before the power supply of the external source device 300 is stopped, the initial driving time may be shortened. Accordingly, the external source device 300 may operate again in an operation state before the power supply is stopped, so as to maintain the continuity in operation of the external source device 300, thereby, providing more convenience to the user.

The electronic apparatus 100 may further include a data interface connected to the external source device 300. The processor 130 may provide the content received via the data interface to the display device 200, and when a control signal is received to change the source device providing the content from the display device 200 to the other external source device, power supply to the external source device may be stopped.

The electronic apparatus 100 may further include the other data interface connected to the other external source device and the other power interface connected to the other external source device. The processor 130 may supply power to the other external source device through the other power interface when a control signal for changing the source device providing the content from the display device 200 to the other external source device is received, and provide the content received through the other data interface to the display device 200. The processor 130 may stop supplying power to the external source device 300.

The electronic apparatus 100 may further include a data interface connected to the external source device 300 and the other data interface connected to the other external source device, and the processor 130 may stop supplying power to the external source device 300 and provide the other content to the display device 200 when the other content is received from the other external source device through the other data interface while providing the content received through the data interface to the display device 200.

The electronic apparatus 100 may further include an IR transmitter, and the processor 130 may control the IR transmitter to transmit a turn-off command to the external source device 300 when a control signal for turning off the display device 200 is received from the display device 200. The processor may also control the IR transmitter to transmit a turn-on command to the external source device 300 when a control signal for turning on the display device 200 is received from the display device 200. That is, the electronic apparatus 100 may turn off the source device 300 by stopping the power supply of the external source device 300 or supply power to the external source device 300 to turn on the external source device 300.

The electronic apparatus 100 may further include a storage. The processor 130 may store usage pattern information including the operation state of the display device 200 and the operation state of the external source device 300 to a storage at certain time intervals, and stop power supply to the external source device 300 based on the usage pattern information.

The electronic apparatus 100 may further include a power supply for providing power and a relay formed between the power supply and the power interface. The processor 130 may open the power supply and the power interface through the relay to stop power supply to the external source device 300. That is, the electronic apparatus 100 may physically block the supply of power to the external source device 300.

The power supply may output power to the power interface 110 based on an external power source, output a first DC power at a first voltage level and a second DC power at a second voltage level that is lower than the first voltage level, to the display device 200 based on an external power source. The processor 130 may stop supplying power to the external source device 300 when a control signal for turning off the display device 200 is received from the display device 200. The processor 130 may stop supplying the first DC power to the display device 200 to cause the display device 200 to operate in a standby mode. In this case, the power supply may output only the second DC power to the display device 200, and the display device 200 may operate in a standby mode based on the second DC power.

The processor 130 may provide setting information including the power supply time of the external source device 300 to a user interface (UI) screen of the display device 200. When the setting information about the power supply time is received from a user through the display device 200, the processor 130 may adjust supplying power to the external source device based on the received information.

FIG. 2A illustrates that one power interface 110 and one communication interface 120 are provided, but the embodiment is not limited thereto. The electronic apparatus 100 may include at least one power interface, at least one communication interface, and at least one data interface.

FIG. 2B is a block diagram illustrating an example of a detailed configuration of the electronic apparatus 100 according to an embodiment. The electronic apparatus 100 may include a power supply interface 110, a communication interface 120, and a processor 130. Referring to FIG. 2B, the electronic apparatus 100 may further include a power supply 140, a relay 150, a data interface 160, an IR transmitter/receiver 170, a storage 180, and a communicator 190. With reference to FIG. 2B, a detailed description will be omitted for the components described above with reference to FIG. 2A.

The power supply 140 may be a device that receives power from the outside and outputs the received power through at least one of the power interface 110 and the communication interface 120. For example, the power supply 140 may receive power from the outside, such as an outlet or a battery, and output the supplied power through the power interface 110. The power supply 140 may convert the received power from the outside to DC power and output the DC power through the communication interface 120.

The power supply 140 may generate a first DC power at a first voltage level and a second DC power at a second voltage level that is lower than the first voltage level from the power source. The processor 130 may control the power supply 140 to provide at least one of the first DC power supply and the second DC power supply to the display device 200 based on a control command received from the display device 200 connected via the communication interface 120. For example, the processor 130 may control the power supply 140 to provide the first DC power supply and the second DC power supply to the display device 200 if the display device 200 is turned on, and may control the power supply 140 to provide only the second DC power to the display device 200 if the display device 200 is in a standby mode. In particular, the processor 130 may control the power supply 140 to not generate a first DC power supply if the display device 200 is in a standby mode.

The relay 150 may be disposed between the power supply interface 110 and the power supply 140. The relay 150 may physically open the power supply interface 110 and the power supply 140 under the control of the processor 130. Accordingly, when the power supply interface 110 and the power supply 140 are opened, consumption of standby power may be reduced.

The data interface 160 is an interface for transceiving data with the external source device 300 and may have standards such as digital visual interface (DVI), display port (DP), high definition multimedia interface (HDMI), mobile high-definition link (MHL), universal serial bus (USB), Thunderbolt, video graphics array (VGA) port, red-green-blue (RGB) port, D-subminiature (D-SUB), component, RS232C communication or the like, but the embodiment is not limited thereto. The data interface 160 may be any standard which is capable of transceiving data with the external source device 300.

The data interface 160 may receive at least one of an audio signal and a video signal from the external source device 300. The data interface 160 may include a port for receiving only the audio signal and a port for receiving only the video signal individually, or may be implemented as a single port for receiving both the audio signal and the video signal.

The IR transmitter and IR receiver 170 are configured to transmit an IR signal and receive the IR signal, respectively. For example, the IR transmitter and IR receiver 170 may include an IR blaster for transmitting the IR signal and an IR sensor for receiving the IR signal, respectively.

The processor 130 may control the IR transmitter and IR receiver 170 to output the IR signal to control the external source device 300. Alternatively, when the IR signal is received via the IR transmitter and IR receiver 170, the processor 130 may perform a corresponding operation.

The storage 180 may be implemented as an internal memory such as, for example, and without limitation, a read only memory (for example, electrically erasable programmable read-only memory (EEPROM)), random-access memory (RAM), or the like, included in the processor 130 or separated from the processor 130. For example, the storage 180 may be implemented as a memory embedded in the electronic apparatus 100, or may be implemented as a detachable memory in the electronic apparatus 100, according to the data usage. For example, data for driving the electronic apparatus 100 may be stored in a memory embedded in the electronic apparatus 100, and data for an expanded function of the electronic apparatus 100 may be stored in the memory detachable to the electronic apparatus 100. A memory embedded in the electronic apparatus 100 may be a volatile memory such as, for example, and without limitation, a dynamic random access memory (DRAM), a static random access memory (SRAM), a synchronous dynamic random access memory (SDRAM), or a nonvolatile memory (for example, one time programmable ROM (OTPROM), programmable ROM (PROM), erasable and programmable ROM (EPROM), electrically erasable and programmable ROM (EEPROM), mask ROM, flash ROM, a flash memory (for example, NAND flash or NOR flash), a hard disk drive, a solid state drive (SSD), or the like. In the case of a memory detachably mounted to the electronic apparatus 100, the memory may be implemented as, for example, a memory card (for example, a compact flash (CF), secure digital (SD), micro secure digital (micro-SD), mini secure digital (mini-SD), extreme digital (xD), multi-media card (MMC), etc.), an external memory (for example, a USB memory) connectable to the USB port, or the like.

The storage 180 may store various data such as an operating system (OS) software module to drive the electronic apparatus 100, a content processing module, a user interface (UI) providing module, a power supply control module, or the like.

The processor 130 may include various processing circuitry and control overall operations of the electronic apparatus 100 using various programs stored in the storage 180.

The processor 130 may include a RAM 131, a ROM 132, a main CPU 133, first interface to n^{th} interface 134-1˜134-n, and a bus 135.

The RAM 131, ROM 132, main CPU 133, a plurality of interfaces 134-1 to 134-n, or the like, may be interconnected through the bus 135.

The ROM 132 may store one or more instructions for booting the system and the like. When the turn-on instruction is input and power is supplied, the CPU 133 copies the OS stored in the storage 180 to the RAM 131 according to the stored one or more instructions in the ROM 132, and executes the OS to boot the system. When the booting is completed, the CPU 133 copies various application programs stored in the storage 180 to the RAM 131, executes the application program copied to the RAM 131, and performs various operations.

The main CPU 133 accesses the storage 180 and performs booting using an operating system (OS) stored in the storage 180, and performs various operations using various programs, contents data, or the like, stored in the storage 180.

The plurality of interfaces 134-1 to 134-n are connected to the various elements described above. For example, one of the interfaces may be a network interface connected to an external device through the network.

The processor 130 may perform a graphic processing function (video processing function). For example, the processor 130 may generate a screen including various objects such as icons, images, text, and the like. A calculator may calculate an attribute value such as a coordinate value, a shape, a size, and a color to be displayed by each object according to the layout of the screen based on the received control command. A renderer may generate display screens of various layouts including objects based on the attribute value calculated by the calculator. The processor 130 may perform various image processing such as decoding, scaling, noise filtering, frame rate conversion, resolution conversion, or the like, for the video data.

The processor 130 may perform processing of audio data. For example, the processor 130 may perform various image processing such as, for example, decoding, amplifying, noise filtering, and the like, on the audio data.

The communicator 190 may include various communication circuitry and communicate with other external devices of various types. The communicator 190 may include various modules including various communication circuitry, such as, for example, a Wi-Fi module 191, a Bluetooth module 192, an infrared communication module 193, a wireless communication module 194, or the like. Each communication module may include communication circuitry and be implemented as at least one hardware chip format.

The processor 130 may communicate with various external devices using the communicator 190. The external device may include, for example, an image processing device such as a set-top box, an external server and a control device (e.g., a remote control), an audio output device (e.g., a Bluetooth speaker), a lighting device, a smart cleaner, a home appliance (e.g., a smart refrigerator), a server (e.g., an Internet of things (TOT) home manager), or the like.

The Wi-Fi module 191 and the Bluetooth module 192 perform communication using Wi-Fi method and Bluetooth method, respectively. When using the Wi-Fi module 191 or the Bluetooth module 192, various connection information such as a service set identifier (SSID) and a session key may be transmitted and received first, and communication information may be transmitted after communication connection.

The infrared ray communication module 193 performs communication according to infrared data association (IrDA) technology that transmits data wireless to local area using infrared ray between visible rays and millimeter waves.

The wireless communication module 194 may refer, for example, to a module performing communication according to various communication standards such as Zigbee, 3^{rd} generation (3G), 3^{rd} generation partnership project (3GPP), long term evolution (LTE), LTE advanced (LTE-A), 4th generation (4G), 5th generation (5G), or the like, in addition to the communication methods described above.

The communicator 190 may include at least one of a local area network (LAN) module, Ethernet module, or wired communication module performing communication using a pair cable, a coaxial cable, an optical cable, or the like.

According to an embodiment, the communicator 190 may use the same communication module (for example, Wi-Fi module) to communicate with an external device such as a remote controller and an external server.

In accordance with another example, the communicator 190 may utilize different communication modules (for example, Wi-Fi modules) to communicate with an external device such as a remote controller and an external server. For example, the communicator 190 may use at least one of an Ethernet module or a Wi-Fi module to communicate with an external server, and may use a Bluetooth (BT) module to communicate with an external device such as a remote controller. However, this is merely an example, and the communicator 190 may use at least one communication module among various communication modules when communicating with a plurality of external devices or an external server.

The electronic apparatus 100 may further include a tuner and a demodulator.

The tuner may receive a radio frequency (RF) broadcasting signal by tuning a channel selected by a user or all the pre-stored channels, from among RF broadcasting signals that are received through the antenna.

A demodulator may receive and demodulate a digital intermediate frequency (DIF) signal that is converted by the tuner, and perform channel decoding, or the like.

The electronic apparatus 100 may further include a user interface. The user interface may be implemented as a device such as, a button, a touch pad, a mouse, and a keyboard, or may be implemented as a touch screen which is capable of performing the aforementioned display function and a manipulation input function as well. The button may be various types of buttons such as a mechanical button, a touch pad, a wheel, and the like formed in an arbitrary area such as a front surface portion, a side surface portion, and a back surface portion of the main body of the electronic apparatus 100.

The electronic apparatus 100 may further include an interface for receiving power from the power socket 10.

As described above, the electronic apparatus 100 may stop supplying power to the external source device 300, thereby preventing standby power consumption of the external source device 300. More specifically, when the electronic apparatus 100 may stop supplying power to the external source device 300 using the relay 150, by which the power supply to the external source device 300 may be physically blocked, and cutting off the power supply to the external source device 300 to zero watts.

Since the external source device 300 is generally used with the display device 200, there may not be a serious problem even if the external source device 300 is powered off when the display device is turned off. Accordingly, there is an effect that the standby power consumption of the external source device 300 is reduced automatically without user intervention. In addition, an internal control circuit for communication, such as a smart plug may not be necessary, thereby preventing additional power consumption.

Hereinbelow, an operation of the electronic apparatus 100 will be further described.

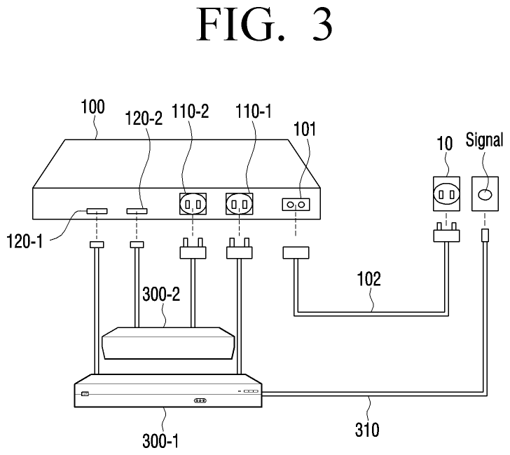

FIG. 3 is a diagram illustrating an operation of the electronic apparatus 100 and a plurality of external source devices 300-1 and 300-2 according to an embodiment.

The electronic apparatus 100 may include an interface 101 for receiving an external power from the power socket 10. The electronic apparatus 100 may receive an external power through a power cable 102 connecting the power socket 10 and the interface 101.

The electronic apparatus 100 may supply power to the first external source device 300-1 through a first power interface 110-1, and transmit and receive data to and from the first external source device 300-1 through the first data interface 120-1. The first external source device 300-1 may receive content from the outside (or signal) via the signal cable 310, and provide the content received via the first data interface 120-1 to the electronic apparatus 100. The first external source device 300-1 may be a set-top box, or the like.

The electronic apparatus 100 may supply power to the second external source device 300-2 through the second power interface 110-2, and transmit and receive data to and from the second external source device 300-2 through the second data interface 120-2. It is assumed that the second external source device 300-2 does not need to receive content from the outside (or signal). The second external source device 300-2 may be a device, such as a Blu-ray player, a DVD player, or the like.

The processor 130 of the electronic apparatus 100 may supply power or stop supplying power to the first external source device 300-1 and the second external source device 300-2 according to a control signal received from the display device 200.

For example, when a control command for turning on the display device 200 is received from the display device 200, the processor 130 may supply power to the first external source device 300-1 and the second external source device 300-2, and may stop supplying power to the first external source device 300-1 and the second external source device 300-2 when a control command for turning off the display device 200 from the display device 200 is received.

The processor 130 may detect whether the display device 200 is turned on and if the display device 200 is turned on, the processor 130 may supply power to the first external source device 300-1 and the second external source device 300-2, and if the display device 200 is turned off, the processor 130 may stop supplying power to the first external source device 300-1 and the second external source device 300-2.

Alternatively, the processor 130 may directly receive a turn-on command or a turn-off command for the display device 200 from a remote control device via the IR receiver. For example, the processor 130 may supply power to the first external source device 300-1 and the second external source device 300-2 when a turn-on command for the display device 200 is received from the remote control device, and when a turn-off command for the display device 200 is received from the remote control device, the processor 130 may stop supplying power to the first external source device 300-1 and the second external source device 300-2.

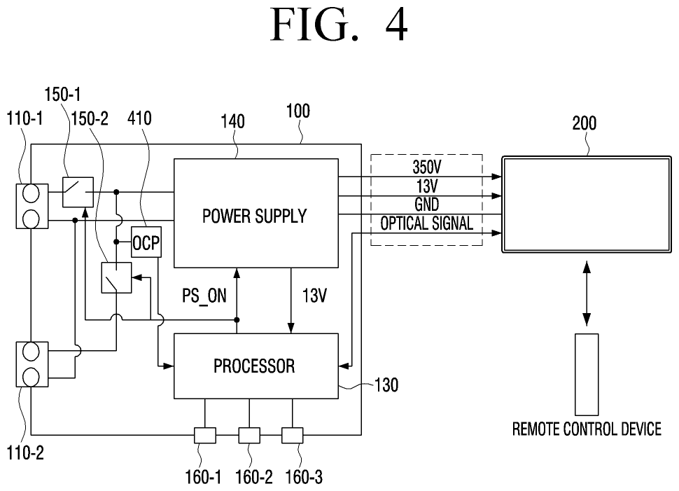

FIG. 4 is a diagram illustrating an internal circuit of the electronic apparatus 100 according to an embodiment.

As shown in FIG. 4, the processor 130 may control the operation of the electronic apparatus 100. For example, the processor 130 may control the power supply 140 to convert received external power to DC power. Specifically, for example, the processor 130 may convert the received external power between 90V to 264V into a DC power of 350V and a DC power of 13V, and supply the converted DC power to the display device 200.

The processor 130 may also be supplied with power from the power supply 140 for driving. For example, the processor 130 may be provided with a DC power supply of 13V from the power supply 140. However, the embodiment is not limited thereto. The power supply 140 may provide a DC power supply having different voltage levels to the processor 130 and the display device 200.

The processor 130 may be connected to the data interfaces 160-1 to 160-3 for receiving content from the external source device 300 and may provide the received content to the display device 200.

The cable connecting the electronic apparatus 100 and the display device 200 may include a plurality of lines. For example, cables connecting the electronic apparatus 100 and the display device 200 may include a line for supplying a DC power supply of 350V, a line for supplying a DC power supply of 13V, a ground line (GND), and a line for transmitting an optical signal.

When a control signal for turning off the display device 200 is received from the display device 200, the processor 130 may generate a picture on (PS_ON) signal (high) and provide the PS_ON signal to the power supply 140 and the relays 150-1 and 150-2. When a control signal for turning on the display device 200 is received from the display device 200, the processor 130 may generate the PS_OFF signal (low) and provide the PS_OFF signal (low) to the power supply 140 and the relays 150-1 and 150-2.

When the PS_ON signal (high) is input, the power supply 140 may stop the output of the DC power supply of 350V. In this case, the power supply 140 may provide the DC power supply voltage of 13V to the controller 130 and the display device 200 so that the display device 200 may operate in the standby mode. When the PS_OFF signal (low) is input, the power supply 140 may output a DC power supply of 350V and a DC power supply of 13V.

The relays 150-1 and 150-2 may open the power supply 140 and the power interfaces 110-1 and 110-2 according to the PS_ON signal (high) to stop power supply to the external source device 300. The relays 150-1 and 150-2 may short-circuit the power supply 140 and the power interfaces 110-1 and 110-2 according to the PS_OFF signal (low) to resume power supply to the external source device 300.

The electronic apparatus 100 may further include an over-current protection (OCP) 410. When the over-current detection circuit 410 is connected to a peripheral device that consumes excessive power, and a current which is higher than or equal to a critical current flows in the circuit, the OCP 410 may transmit, to the processor 130, an over-current generation signal indicating that an over-current has occurred. When the over-current generation signal is received by the processor 130, the processor 130 may generate the PS_ON signal (high) to remove the overcurrent. Through this operation, the circuit inside the relay and the electronic apparatus 100 may be prevented from being damaged.

In FIG. 4, one over-current protection (OCP) 410 is connected to the relays 150-1 and 150-2, but one OCP 410 may be connected to each relay.

It has been described that an operation state of the relays 150-1 and 150-2 may be determined according to a control signal to turn on or turn off the display device 200, but the embodiment is not limited thereto.

For example, if a control signal for turning off the display device 200 is received by the processor 130, the processor 130 may store information on a source device that provides content to the display device 200. Thereafter, when a control signal for turning on the display device 200 is received, the processor 130 may supply power to one of the first external source device 300-1 and the second external source device 300-2 based on the stored information of the source device. When a control signal for changing the source device from the display device 200 to the other of the first external source device 300-1 and the second external source device 300-2 is received, the processor 130 may supply power to the other one of the first external source device 300-1 and the second external source device 300-2, and stop supplying power to one of the first external source device 300-1 and the second external source device 300-2. For example, if the processor receives a control signal for changing from the first external source device 300-1 to the second external source device 300-2 to receive contents, the processor 130 may supply power to the second external source device 300-2 while cutting off power to the first external source device 300-1.

Alternatively, the processor 130 may further consider whether the content is provided actively. For example, the processor 130 may supply power to the first external source device 300-1 and the second external source device 300-2 according to a control signal that turns on the display device 200. The processor 130 may stop supplying power to the other of the first external source device 300-1 and the second external source device 300-2 when content is received from one of the first external source device 300-1 and the second external source device 300-2. That is, after providing power supply to the first external source device 300-1 and the second external source device 300-2, if one of the first external source device 300-1 and the second external source device 300-2 is turned on by the user to provide content to the processor 130, the processor 130 may maintain power supply to the source device that provides the content, and stop the supply of power to the other source device.

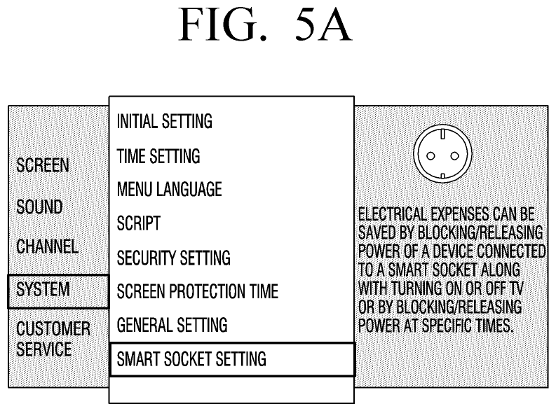

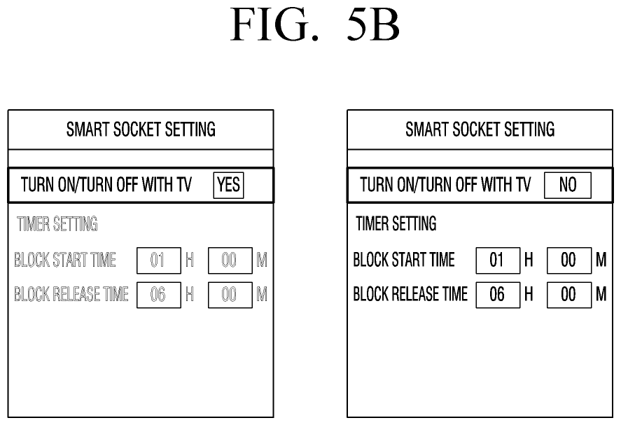

FIGS. 5A and 5B are diagrams illustrating a user interface (UI) screen according to an embodiment.

In FIG. 4, it has been described that the processor 130 controls the relay 150 based on at least one of a control command received from the display device 200 and based on determining whether to provide content to the display device 200, but the embodiment is not limited thereto.

For example, the processor 130 may transmit on-screen display (OSD) screen information as shown in FIG. 5A to the display device 200. A user may select a smart socket setting on the OSD display screen displayed on the display device 200 by using a remote control device. The display device 200 may transmit a control command corresponding to a smart socket setting to the processor 130.

Referring to FIG. 5B, when a control command selecting the smart socket setting is received from the user, the processor 130 may transmit the screen information, such a screen on a left side, to the display device 200. The left screen may include a region to set linking between whether to supply power to the external source devices based on the power status of the display device (e.g., TV) 200. If the smart socket setting to link the display device 200 to the external source devices 300 is not turned on, a region for setting a timer, such as a screen on the right may be activated, and the user may supply power to the external source device 300 at a desired time.

Furthermore, the processor 130 may transmit screen information which may be differently configured for each of a plurality of relays to the display device 200. Accordingly, different settings are possible for each type of the external source device 300.

For example, the user may set the set-top box to operate in association with the power status of the display device 200, and the processor 130 may control the first relay 150-1 connected through the set-top box and the first power interface 110-1 based on the display device 200 being turned on or off. The user may set an artificial intelligence (AI) speaker to always receive power regardless of whether the display device 200 is turned on or not, and the processor 130 may control the second relay 150-2 connected through the AI speaker and the second power interface 110-2 to always maintain the short-circuit state.

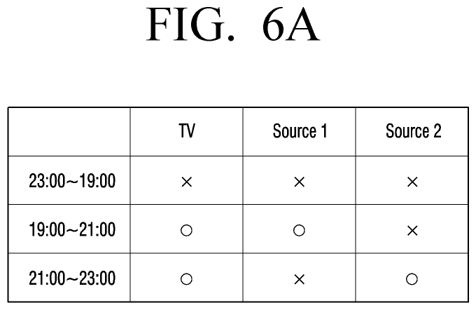

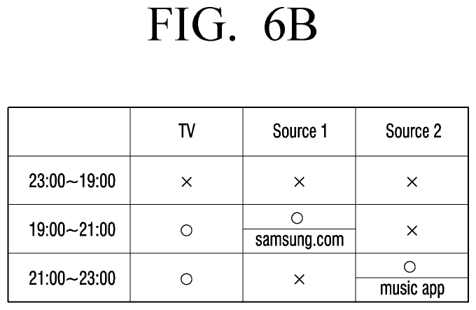

FIGS. 6A and 6B are diagrams illustrating a method for using a usage pattern according to various embodiments.

The processor 130 may generate a usage pattern that indicates a manner in which the user uses the display device and the external source device. For example, the processor 130 may generate a usage pattern of a display device TV, a first external source device (source 1) and a second external source device (source 2) for certain time intervals, as illustrated in FIG. 6A.

The processor 130 may generate a usage pattern in consideration of whether the device is used for each predetermined time period, the time of use, a relationship with another device, etc. The usage pattern shown in FIG. 6A is only an example, and a usage pattern may be generated in various ways.

The processor 130 may determine whether to supply power to the external source device based on the usage pattern. For example, if the display device TV is generally turned on between 19:00 and 21:00, the processor 130 may supply power to the first external source device (source 1), and if the display device TV is turned on between 21:00 and 23:00, the processor 130 may supply power to the second external source device (source 2).

The processor 130 may also generate a usage pattern that includes the operation state of the external source device. For example, the processor 130 may store, as shown in FIG. 6B, that the first external source device is in a state that provides a web page of Samsung.com between 19:00 and 21:00. Further, as shown in FIG. 6B, the processor 130 may store a state in which the second external source device executes the music application between 21:00 and 23:00 and provides a graphical user interface (GUI) corresponding to the music application, as shown in FIG. 6B.

The processor 130 may determine whether to supply power to the external source device based on the usage pattern and control the operation state of the external source device. For example, the processor 130 may supply power to the first external source device when the display device is turned on between 19:00 and 21:00, and control the first external source device to provide a web page of Samsung.com. When the display device is turned on between 21:00 and 23:00, the processor 130 may supply power to the second external source device, and control the second external source device to execute the music application. That is, the processor 130 may supply power to the external source device while simultaneously providing the last stored state information of the external source device to the external source device.

FIG. 6B illustrates an operation state of a music application and a web page address for convenience, but the embodiment is not limited thereto. For example, the operation state of the external source device may further include login information of a web page, reproduction information, channel information, volume information, or the like, of a moving image or a music application.

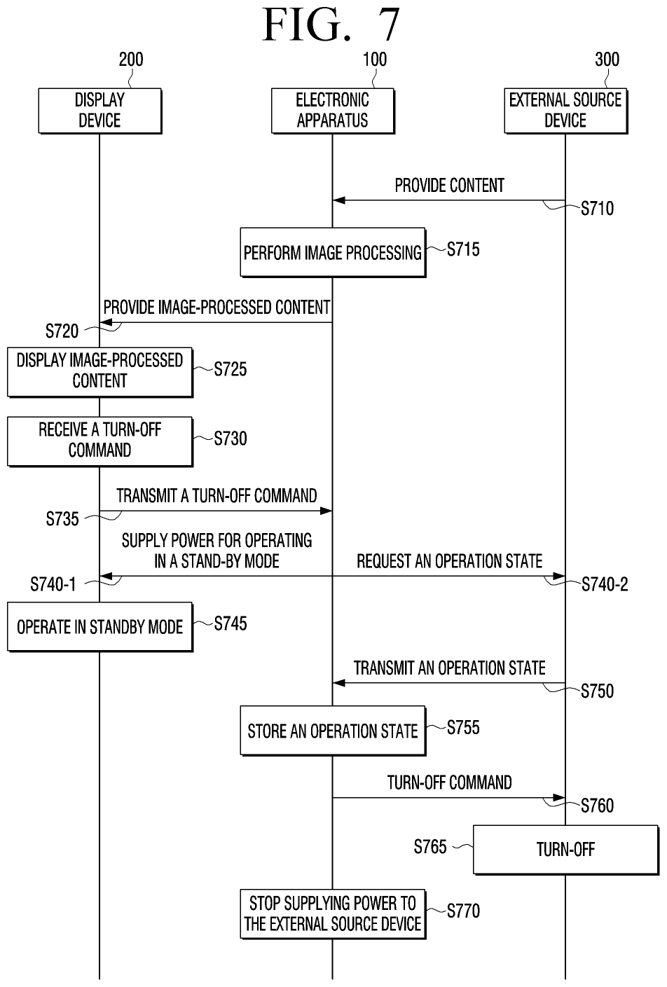

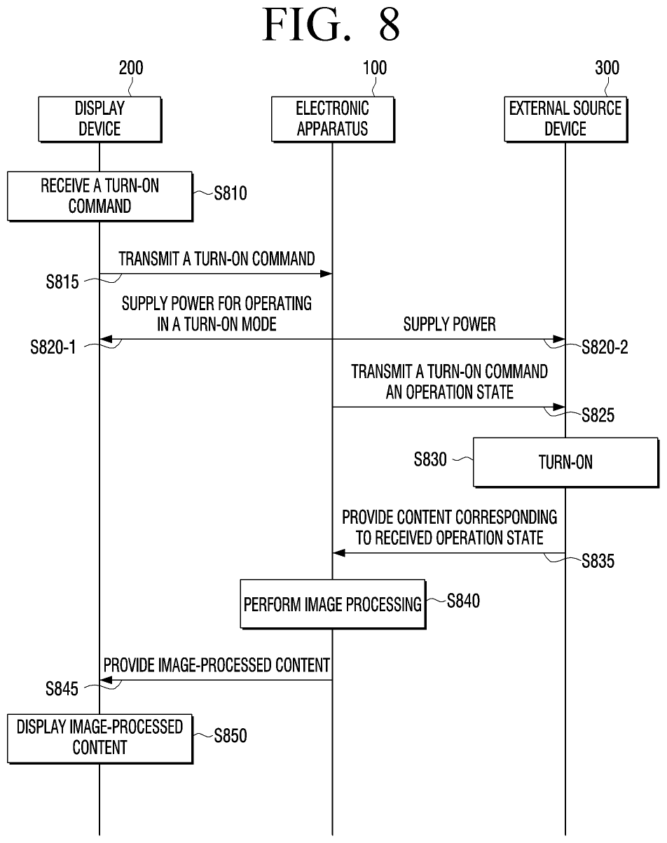

FIGS. 7 and 8 are sequence diagrams illustrating a method for controlling an operation of an external source device according to an embodiment.

In FIG. 7, it is assumed that the display device 200 is turned on. The external source device 300 may provide content to the electronic apparatus 100 in operation S710. For example, the external source device 300 may provide encoded content to the electronic apparatus 100.

The electronic apparatus 100 may perform image processing for the received content in operation S715. For example, the electronic apparatus 100 may decode the received content. The embodiment is not limited thereto and the electronic apparatus 100 may convert at least one of a frame rate or resolution of the received content.

The electronic apparatus 100 may provide image-processed content to the display device 200 in operation S720, and the display device 200 may display the image-processed content in operation S725.

The display device 200 may receive a turn-off command in operation S730 from a user or other devices, and transmit the turn-off command to the electronic apparatus 100 in operation S735.

When the turn-off command is received, the electronic apparatus 100 may supply power to operate the display device 200 in a standby mode in operation S740-1, and request an operation state of the external source device 300 to the external source device 300 in operation S740-2. For example, the electronic apparatus 100 may supply a DC power source of 350V and a DC power supply of 13V to the display device 200 until a turn-off command is received, and may supply only a DC power supply of 13V to the display device 200 to operate in a standby mode.

It has been described that the operation S740-1 of supplying power for operating in the standby mode and the operation S740-2 for requesting the operation state to the external source device 300 are performed simultaneously. However, it is not limited thereto and the two operations may be sequentially performed.

In operation S745, the display device 200 operates in a standby mode. On the other hand, the external source device 300 may transmit an operation state of the external source device 300 to the electronic apparatus 100 in operation S750, and the electronic apparatus 100 may store the received operation state in operation S755. Here, the operation state of the external source device 300 may include various information such as an application executed on the external source device 300, information about the content provided by the external source device 300 to the electronic apparatus 100, or the like. For example, the operation state of the external source device 300 may include an Internet web page to which the external source device 300 accessed, login information for the web page, channel information of the content provided by the external source device 300, volume information, content information, or the like.

The electronic apparatus 100 may store an operation state, transmit a turn-off command to the external source device 300 in operation S760, and the external source device 300 may be turned off according to the turn-off command in operation S765. The embodiment is not limited thereto and the electronic apparatus 100 may request an operation state to the external source device 300 and transmit a turn-off command. In this case, the external source device 300 may transmit the operation state to the electronic apparatus 100 and may be turned off.

Thereafter, the electronic apparatus 100 may stop supplying power to the external source device 300 in operation S770.

In FIG. 8, it may be assumed that the display device 200 and the external source device 300 are turned off initially, and the electronic apparatus 100 stores an operation state of the external source device 300.

The display device 200 may receive a turn-on command from a user or another device in operation S810 and transmit the turn-on command to the electronic apparatus 100 in operation S815.

When the turn-on command is received, the electronic apparatus 100 may supply power for operating the display device 200 to operate in the turn-on mode in operation S820-1, and supply the power to the external source device 300 in operation S820-2. For example, the electronic apparatus 100 may supply only a DC power supply of 13V to the display device 200 until a turn-on command is received, and supply a DC power supply of 350V and a DC power supply of 13V to the display device 200 when a turn-on command is received. The display device 200 may be turned on when a DC power supply of 350V and a DC power supply of 13V are supplied.

It has been described that an operation S820-1 of supplying power to operate in a turn-on mode and an operation S820-2 of supplying power to the external source device 300 are performed simultaneously, but the embodiment is not limited thereto. The operations may be performed sequentially. That is, the electronic apparatus 100 may supply power to the external source device 300, and then supply the DC power of 350V and 13V to the display device 200, or vice versa.

The electronic apparatus 100 may transmit a turn-on command and an operation state to the external source device 300 in operation S825 and the external source device 300 may provide the content that is turned on in operation S830 and received to the electronic apparatus 100 in operation S835.

For example, if the operation state stored in the electronic apparatus 100 is the information accessed by the external source device 300 to the web page of the Samsung.com, the external source device 300 may access the web page of the Samsung.com after the external source device 300 is turned on, and the external source device 300 may transmit the corresponding screen information to the electronic apparatus 100. Specifically, if the operation state stored in the electronic apparatus 100 includes information logged into the web page of Samsung.com, then the external source device 300 may access the web page of Samsung.com, log into the web page of Samsung.com, and transmit the logged-in screen information to the electronic apparatus 100.

If the operation state stored in the electronic apparatus 100 is the information that the external source device 300 executes the music application, the external source device 300, after being turned on, may execute the music application, and transmit the corresponding screen information to the electronic apparatus 100. If the operation state stored in the electronic apparatus 100 includes information about the music being reproduced in the music application and reproduction time in the music application, the external source device 300 may execute the music application, reproduce music from the reproduction point of music included in the operation state, and transmit the corresponding screen information to the electronic apparatus 100. This operation may also apply to a moving image or video.

The electronic apparatus 100 may perform image processing for the received content in operation S840 and provide the processed image content to the display device 200 in operation S845. The display device 200 may display the processed image content in operation S850.

As described above, the electronic apparatus 100 may store the operation state of the external source device 300 before stopping power supply to the external source device 300 according to the turn-off command of the user, and provide an operation state of the external source device 300 to the external source device 300. By doing so, the external source device 300 may search and provide the content last played on the display device 200 before the turn-off command, and the display device 200 may reproduce the content from a time point at which the user left off, thereby providing continuity in the use of the external source device 300.

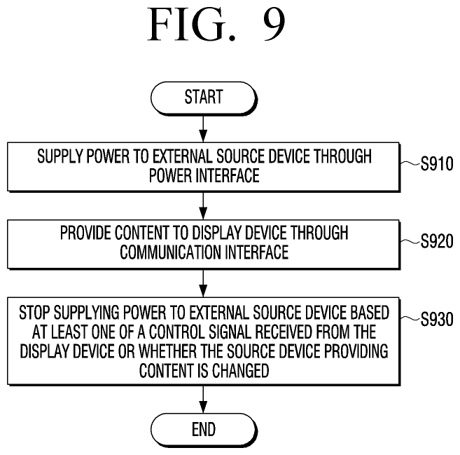

FIG. 9 is a flowchart illustrating a control method of an electronic apparatus according to an embodiment.

First, power is supplied to the external source device through the power interface in operation S910. The contents are provided to the display device through the communication interface in operation S920. In operation S930, the power supply to the external source device may be stopped based on a control signal indicating at least one of the power status of the display device being changed or the source device providing the content being changed.

The step of stopping in operation S930 may include stopping power supply to an external source device when a control signal to turn off the display device is received from the display device.

The step of stopping in operation S930 may also include, when the control signal for turning off the display device is received from the display device, requesting the operation state information of the external source device to the external source device, and based on the operation state information being received from the external source device, stopping supplying power to the external source device, and the control method may further include, based on a control signal to turn on the external source device being received from the display device, providing power and operation state information to the external source device.

The step of providing content in operation S920 may include providing the content received via the data interface connected with the external source device to the display device, and the step of stopping in operation S930 may include stop supplying power to the external source device when a control signal for changing the source device providing the content from the display device to the other external source device is received.

The method may further include supplying power to the other external source device through the other power interface connected to the other external source device when a control signal for changing the source device providing the content from the display device to the other external source device is received, and providing the content received through the other data interface connected to the other external source device to the display device.

The step of stopping in step S930 may further include, when the other content is received from the other external source device through the other data interface connected to the other external source device while providing the content received through the data interface connected to the external source device to the display device, the power supply to the external source device is stopped, and the control method may further include the step of providing the other content to the display device.

The method may further include transmitting a turn-off command to the external source device when a control signal for turning off the display device from the display device is received, and transmitting a turn-on command to the external source device when a control signal for turning on the display device from the display device is received.

The method may further include storing usage pattern information including an operation state of the display device and an operation state of the external source device, and the stopping in operation S930 may include stopping power supply to the external source device based on the usage pattern information.

The method may further include the step of providing a UI screen for setting the power supply time of the external source device to the display device, and the operation of stopping in operation S930 may include stopping the supply of power to the external source device based on the received information when the setting information about the power supply time is received from the display device.

According to various embodiments as described above, the electronic apparatus may stop supplying power to an external source device, thereby preventing consumption of standby power in the external source device.

In addition, various example embodiments as described above may be implemented with software including instructions stored in the machine-readable storage media readable by a machine (e.g., computer). According to one or more embodiments, an apparatus may call instructions from the storage medium and operate according to the called instructions. When an instruction is executed by a processor, the processor may perform functions corresponding to the instruction, either directly or under the control of the processor using other components. The instructions may include a code constructed by a compiler or a code executable by an interpreter. A machine-readable storage medium may be provided in the form of a non-transitory storage medium. Here, “non-transitory” means that the storage medium does not contain a signal and is tangible, and it is not considered that the data is stored semi-permanently or temporarily in the storage medium.

According to various example embodiments of the disclosure, a method may be provided in a computer program product. A computer program product may be exchanged between a seller and a purchaser as a commodity. A computer program product may be distributed in the form of a machine-readable storage medium (e.g., compact disc read only memory (CD-ROM)) or distributed online through an application store (e.g. PlayStore™) In the case of on-line distribution, at least a portion of the computer program product may be stored temporarily or at least temporarily in a storage medium such as a manufacturer's server, a server of an application store, or a memory of a relay server.

The above-described various embodiments may be implemented in a computer- or similar device-readable recording medium using software, hardware, or a combination thereof. In some embodiments, the embodiments described herein may be implemented by the processor itself. Through the software implementation, the embodiments such as a procedure and function described herein may be implemented with separate software modules. The software modules may perform one or more functions and operations described herein.

Computer instructions for performing the processing operations of a device according to various embodiments described above may be stored in a non-transitory computer-readable medium. The computer instructions stored in the non-transitory computer-readable medium, when executed by a processor of a particular device, may cause a particular device to perform processing operation in the device according to the various embodiments described above. A non-transitory computer-readable medium refers to a medium that stores data semi-permanently, rather than a medium that stores data for a short time, such as a register, cache, memory, etc., and is capable of being read by a device. A specific example of a non-transitory computer-readable medium may be a compact disc (CD), a digital versatile disc (DVD), a hard disk, a Blu-ray disc, a universal serial bus (USB), a memory card, a read only memory (ROM), and the like.

Each of the elements (for example, a module or a program) according to various example embodiments may include a single entity or a plurality of entities, and some sub-elements of the above-mentioned sub-elements may be omitted. The elements may be further included in various embodiments. Additionally, some elements (e.g., modules or programs) may be integrated into one entity to perform the same or similar functions performed by each respective element prior to integration. Operations performed by a module, program, or other element, in accordance with various embodiments, may be performed sequentially, repetitively, heuristically, or in parallel manner, or at least some operations may be performed in a different order.

While various embodiments have been illustrated and described with reference to the accompanying drawings, the disclosure is not limited to the example embodiments herein, and it will be understood by those of ordinary skill in the art that various changes in form and details may be made therein without departing from the spirit and scope of the disclosure.

What is claimed is:

1. An electronic apparatus comprising:
a communication interface configured to be connected to a display device;
a power interface configured to be connected to a first external source device; and
a processor configured to:
control the power interface to supply power to the first external source device,
control the communication interface to transmit content provided from the first external source device, to the display device, and
based on at least one of a control signal received from the display device and whether a source device providing the content is changed, stop supplying the power to the first external source device.

2. The electronic apparatus of claim 1, wherein the processor is further configured to, based on a control signal to turn off the display device being received from the display device, control the power interface to stop supplying the power to the first external source device.

3. The electronic apparatus of claim 2, wherein the processor is further configured to:
based on the control signal to turn off the display device being received from the display device, control the power interface to transmit a request for operation state information of the first external source device, to the first external source device,
based on the operation state information being received from the first external source device, stop supplying the power to the first external source device, and
based on a control signal to turn on the first external source device being received from the display device, supply the power and provide the operation state information to the first external source device.

4. The electronic apparatus of claim 1, further comprising:
a first data interface configured to be connected to the first external source device,
wherein the processor is further configured to:
provide the content received through the first data interface to the display device, and
based on a control signal to change the first external source device providing the content to a second external source device being received from the display device, stop supplying the power to the first external source device.

5. The electronic apparatus of claim 4, further comprising:
a second data interface configured to be connected to the second external source device; and
a second power interface configured to be connected to the second external source device,
wherein the processor is further configured to:
based on the control signal to change the first external source device providing the content to the second external source device being received from the display device, supply power to the second external source device through the second power interface, and
provide the content received through the second data interface to the display device.

6. The electronic apparatus of claim 1, further comprising:
a first data interface configured to be connected to the first external source device; and
a second data interface configured to be connected to a second external source device,
wherein the processor is further configured to:
based on second content from the second external source device being received through the second data interface while the content received through the first data interface being provided to the display device, stop supplying the power to the first external source device and provide the second content to the display device.

7. The electronic apparatus of claim 1, further comprising:
an infrared (IR) transmitter,
wherein the processor is further configured to:
based on a control signal to turn off the display device being received from the display device, control the IR transmitter to transmit a turn-off command to the first external source device, and
based on a control signal to turn on the display device being received from the display device, control the IR transmitter to transmit a turn-on command to the first external source device.

8. The electronic apparatus of claim 1, further comprising:
a storage,
wherein the processor is further configured to:
store usage pattern information including an operation state of the display device and an operation state of the first external source device in the storage by time intervals, and
stop supplying the power to the first external source device based on the usage pattern information.

9. The electronic apparatus of claim 1, further comprising:
a power supply configured to provide the power; and
a relay provided between the power supply and the power interface,
wherein the processor is further configured to stop supplying the power to the first external source device by opening the relay between the power supply and the power interface.

10. The electronic apparatus of claim 9, wherein the power supply is further configured to output the power to the power interface based on an external power and output a first direct current (DC) power at a first voltage level and a second DC power at a second voltage level, the second voltage level being lower than the first voltage level,
wherein the processor is further configured to, based on a control signal to turn off the display device being received from the display device, stop supplying the power to the first external source device and supplying the first DC power to the display device.

11. The electronic apparatus of claim 1, wherein the processor is further configured to:
provide setting information on a user interface screen on the display device for setting a power supply time for the first external source device, and
based on the setting information of the power supply time being received from the display device, stop supplying the power to the first external source device based on the received setting information.

12. A control method of an electronic apparatus, the method comprising:
supplying power to a first external source device through a power interface;
transmitting content provided from the first external source device, to a display device through a communication interface; and
based on at least one of a control signal received from the display device and whether a source device providing the content is changed, stopping the supplying the power to the first external source device.

13. The method of claim 12, wherein the stopping the supplying the power comprises, based on a control signal to turn off the display device being received from the display device, stopping the supplying the power to the first external source device.

14. The method of claim 13, wherein the stopping the supplying the power further comprises:
based on the control signal to turn off the display device being received from the display device, transmitting a request for operation state information of the first external source device, to the first external source device;
based on receiving the operation state information from the first external source device, stopping the supplying the power to the first external source device,
wherein the control method further comprises:
based on a control signal to turn on the first external source device being received from the display device, supplying the power and providing the operation state information to the first external source device.

15. The method of claim 12, wherein the providing further comprises providing, to the display device, content received through a first data interface connected to the first external source device,
wherein the stopping further comprises, based on a control signal to change the first external source device providing the content to a second external source device being received from the display device, stopping the supplying the power to the first external source device.

16. The method of claim 15, further comprising:
based on the control signal to change the first external source device providing the content to the second external source device being received from the display device, supplying power to the second external source device through a second power interface connected to the second external source device; and
providing, to the display device, second content received through a second data interface connected to the second external source device.

17. The method of claim 12, wherein the stopping the supplying the power further comprises:
based on receiving second content from a second external source device through a second data interface connected to the second external device while the content received through a first data interface is being provided to the display device, stopping the supplying the power to the first external source device,
wherein the control method further comprises providing the second content to the display device.

18. The method of claim 12, further comprising:
based on a control signal to turn off the display device being received from the display device, transmitting a turn-off command to the first external source device, and
based on a control signal to turn on the display device being received from the display device, transmitting a turn-on command to the first external source device.

19. The method of claim 12, further comprising:
storing usage pattern information including an operation state of the display device and an operation state of the first external source device by time intervals,
wherein the stopping further comprises stopping the supplying the power to the first external source device based on the usage pattern information.

20. The method of claim 12, further comprising:
providing setting information on a user interface (UI) screen on the display device for setting a power supply time for the first external source device,
wherein the stopping the supplying the power further comprises, based on receiving the setting information of the power supply time from the display device, stopping the supplying the power to the first external source device based on the received setting information.
